(19) United States
(12) Patent Application Publication
(10) Pub. No.: US 2023/0275524 A1
(43) Pub. Date: Aug. 31, 2023

(54) AN APPARATUS FOR REGULATING THE VOLTAGE DELIVERED TO A LOAD

(71) Applicant: BRISTOL BLUEGREEN LTD, Bristol (GB)

(72) Inventors: Paul SILCOCK, Liverpool (GB); Michael HOUGHTON, Liverpool (GB)

(21) Appl. No.: 18/019,917

(22) PCT Filed: Aug. 6, 2021
(86) PCT No.: PCT/GB2021/052050

§ 371 Date: Feb. 6, 2023

(30) Foreign Application Priority Data
Aug. 7, 2020 (GB) 2012325.3

(51) Int. Cl. H02M 5/12; H02M 1/00

(52) U.S. Cl. CPC H02M 5/12; H02M 1/0009

(57) ABSTRACT

A transformer for adjusting the voltage supplied to a load, the transformer comprising a primary winding connectable to a primary AC electrical supply and a secondary winding connectable in series between a live supply and a load. The primary winding comprises a switching means operable to change the number of turns of the primary winding connectable to the primary AC electrical supply where the number of turns of the primary winding connectable to the primary AC electrical supply is greater than a number of turns in the secondary winding. The switching means comprises one or more solid state switches.

This invention relates to an apparatus for regulating the voltage delivered to a load. In particular, the invention relates to a transformer for regulating the voltage of a live supply and delivering the regulated supply to a load.

### BACKGROUND

Electrical distribution networks deliver power over a range of permitted voltages. As such, a load, such as in a property, connected to a live supply from a distribution network is provided with a fluctuating voltage. The voltage provided to a load may be regulated to provide a reduced, constant voltage to the load. Such regulation may provide benefits such as a reduction in the cost of the energy consumed and an improvement in the performance and efficiency of the load.

It is known to regulate the voltage provided to a load by using an on-load tap changer (OLTC). OLTCs may be motorized or manually operated to mechanically change the number of turns of a secondary winding of a transformer. Thus, the turns ratio of the transformer can be modified to regulate the voltage provided to a load. However, due to the mechanical nature of OLTCs, they are typically expensive and require regular maintenance, thereby incurring significant downstream costs. An OLTC typically requires maintenance every 100,000 actuations. Additionally, combining a new transformer with an OLTC may cost in the order of tens of thousands of pounds (GBP) and the cost may vary when combining an existing transformer with an OLTC depending on the compatibility of the devices.

An apparatus for controlling the voltage provided to a load is described in GB2518291A. The apparatus comprises a transformer with a predetermined turns ratio and a power converter. The power converter is arranged to vary the voltage applied to the primary winding to regulate the voltage supplied to the load. However, for large loads, such a regulation scheme may produce high currents in the primary winding as a result of the fixed turns ratio. For example, a transformer with a turns ratio of 8:1 and regulating a 32A load will create a 4A primary current. For a 320A load, the primary current increases to 40A, meaning the size and cost of the power converter is significantly increased: large and expensive components are required on the primary side to ensure adequate regulation of the load voltage.

It is an object of embodiments of the invention to at least mitigate one or more of the problems of the prior art. It is an aim of certain embodiments of the present invention to provide a transformer that regulates the voltage provided to a load that is compact, has reduced manufacturing costs and is inexpensive to maintain.

### BRIEF SUMMARY OF THE DISCLOSURE

In accordance with an aspect of the present invention, there is provided a transformer for adjusting the voltage delivered to a load, the transformer comprising:
a primary winding connectable to a primary AC electrical supply;
a secondary winding connectable in series between a live supply and a load;
wherein the primary winding comprises a switching means operable to change the number of turns of the primary winding connectable to the primary AC electrical supply; wherein the number of turns of the primary winding connectable to the primary AC electrical supply is greater than a number of turns in the secondary winding; and wherein the switching means comprises one or more solid state switches.

The primary winding may comprise a plurality of coils, wherein the switching means may be operable to connect one or more of the plurality of coils in series. The switching means may comprise a set of first switches operable to change the number of turns of the primary winding connectable to the primary AC electrical supply, and wherein the output of each of the plurality of coils in the primary winding may be connected to one of the first switches. The switching means may comprise a set of second switches connected in parallel with each of the plurality of coils.

The primary winding may comprise a tapped coil. The switching means may comprise a set of first switches operable to change the number of turns of the primary winding connectable to the primary AC electrical supply, and wherein the output of the tapped coil in the primary winding may be connected to one of the first switches. The switching means may comprise a set of second switches connected between each tap of the tapped coil.

The transformer may comprise a resistor connected in series with each of the second switches.

The switching means may be operable to change the number of turns of the primary winding that are connectable to the primary AC electrical supply so that the transformer has a turns ratio of X:1, where X is between 2 and 50.

The switching means may be operable to change the number of turns of the primary winding that are connectable to the primary AC electrical supply so that the transformer has a turns ratio of X:1, wherein X is between 3 and 7, 8 and 12, or 15 and 25.

The first switching means may be operable to change the number of turns of the primary winding that are connectable to the primary AC electrical supply so that the transformer has a turns ratio of 5:1, 10:1 and 20:1.

In certain embodiments of the transformer, the primary winding may be connected to a primary AC electrical supply and/or the secondary winding may be connected in series between a live supply and a load.

The primary AC electrical supply may comprise a power converter wherein the power converter is arranged to vary the voltage applied to the primary winding.

In accordance with an aspect of the present invention, there is provided a system for adjusting the voltage received by a load, comprising:
a transformer according to any one of the preceding claims, wherein the secondary winding is connected in series between a live supply and a load;
a detection means configured to measure a voltage of the live supply and/or a voltage delivered to the load;
a control means operably coupled to the switching means and configured to receive data relating to the measured voltage of the live supply and/or live output from the detection means;
wherein the control means is configured to operate the switching means to change the number of turns of the primary winding connectable to the primary AC electrical supply in response to the received measured voltage data so that, in use, the voltage delivered to the load is adjusted.

The system may comprise a first current sensor arranged to measure the current in the secondary winding or the load, wherein the control means may be arranged to receive a signal from the first current sensor and the control means may be configured to operate the switching means to change the number of turns of the primary winding connectable to the primary AC electrical supply in response to the received measured current data so that, in use, the current in the primary winding is kept below the threshold value.

The system may comprise a bypass mechanism controllable by the control means, wherein the bypass mechanism may be configured to connect either the secondary winding between the live supply and the load or the live supply directly to the load.

The system may comprise a temperature sensing means to determine the temperature of the transformer, wherein the control means may be arranged to receive a signal from the temperature sensing means and operate the bypass mechanism in dependence on the determined temperature. The control means may be arranged to operate the bypass mechanism when the determined temperature is at or above a threshold temperature.

The system may comprise a current sensor arranged to measure the current in the secondary winding, wherein the control means may be arranged to receive a signal from the current sensor and operate the bypass mechanism in dependence on the measured current.

The control means may be arranged to operate the bypass mechanism when the measured current is at a threshold current.

The system may comprise monitoring means to measure the noise on the live supply, wherein the control means may be arranged to receive a signal from the monitoring means and operate the bypass mechanism in dependence on the measured noise. The control means may be arranged to operate the bypass mechanism when the measured noise is at a threshold level.

The control means may be arranged to control the bypass mechanism to connect the live supply directly to the load when the measured voltage of the live supply is within a first range of an intended supply voltage for the load and, optionally, wherein the first range is ±2 V, ±4 V or ±6 V from the intended supply voltage.

The control means may be arranged to control the bypass mechanism to connect the secondary winding between the live supply and the load when the measured voltage of the live supply deviates from the intended supply voltage for the load by a second range and, optionally, wherein the second range is ±4 V, ±6 V or ±8 V from the intended supply voltage.

The bypass mechanism may comprise a bypass path to connect the live supply directly to the load.

The system may comprise a switching device to control the orientation of the connection of the primary winding to the primary AC electrical supply, wherein the switching device is controllable by the control means.

In certain embodiments of the system, the primary winding may be connected to a primary AC electrical supply. The primary AC electrical supply may comprise a power converter wherein the power converter is arranged to vary the voltage applied to the primary winding.

### BRIEF DESCRIPTION OF THE DRAWINGS

Embodiments of the invention are further described hereinafter with reference to the accompanying drawings, in which:

FIG. 1 schematically shows a circuit diagram of a transformer according to an embodiment of the invention;

FIG. 2 schematically shows a circuit diagram of a transformer according to another embodiment of the invention;

FIG. 3 schematically shows a circuit diagram of a transformer according to another embodiment of the invention; and

FIG. 4 shows a block diagram of a system according to an embodiment of the invention.

### DETAILED DESCRIPTION

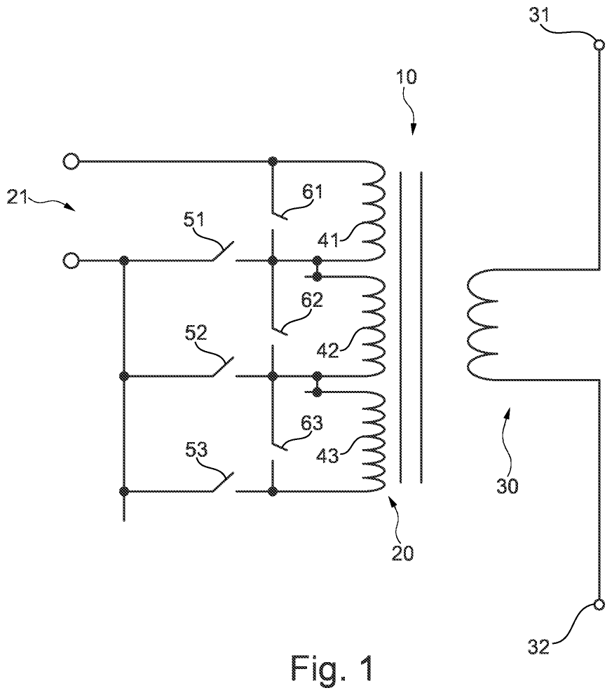

FIG. 1 shows a transformer 10 according to an embodiment of the invention. The transformer 10 comprises a primary winding 20 and a secondary winding 30. The primary winding is connected to a primary AC electrical supply 21. The secondary winding 30 is connected in series between a live supply 31 and a load 32. The transformer 10 may be used to regulate a voltage provided to the load 32 by selectively increasing or decreasing the voltage provided by the live supply 31. For example, the voltage provided to the load 32 may be reduced when the voltage of the live supply is high; thus, reducing energy consumed by the load. The transformer may be used in industrial and commercial applications or on the supply network, for example in a substation, to control the voltage provided to the load 32.

The transformer 10 has a variable turns ratio. The turns ratio is varied by changing the number of turns in the primary winding 20 connected to the AC electrical supply. The secondary winding 30 may have a predetermined number of turns. However, the number of turns of the primary winding 20 connected to the primary AC electrical supply 21 is greater than the number of turns in the secondary winding 30. The turns ratio of the transformer 10 may be changed to control the voltage induced in the secondary winding 30 by the primary winding 20 thereby regulating the voltage supplied to the load 32.

The primary winding 20 comprises a switching means operable to change the number of turns of the primary winding 20 connected to the primary AC electrical supply 21. By operating the switching means, the turns ratio of the transformer 10 may be varied. The turns ratio may be changed as the transformer is being used, thus, there is no need to disconnect the transformer from the AC electrical supply to change the turns ratio. The switching means comprises one or more solid state switches. Solid state switches are advantageous because such switches have no moving parts. As such, the maintenance and servicing required by the transformer 10 is reduced in contrast to the prior art arrangements.

In certain embodiments, the primary winding 20 may comprise a plurality of coils 41, 42, 43 where the switching means is operable to connect one or more of the plurality of coils 41, 42, 43 in series. In the non-limiting embodiment shown in FIG. 1, the primary winding 20 comprises a first coil 41, a second coil 42 and a third coil 43 connected in series. The switching means may comprise a first set of switches 51, 52, 53 where the output of each of the plurality of coils 41, 42, 43 is connected to one of the first set of switches 51, 52, 53. By opening and closing the first set of switches 51, 52, 53, the turns ratio of the transformer 10 can be changed. In the embodiment shown in FIG. 1, the first set of switches 51, 52, 53 comprises a first switch 51, a second switch 52 and a third switch 53. To connect only the first coil 41 to the primary AC electrical supply 21 the first switch 51 is closed and the second 52 and third switches 53 are open. To connect both the first 41 and second 42 coils to the primary AC electrical supply 21, the first 51 and third 53 switches are open, and the second 52 switch is closed. Similarly, to connect all three coils 41, 42, 43 to the primary AC electrical supply 21 the first 51 and second 52 switches are open, and the third switch 53 is closed.

As shown in FIG. 1, the switching means may comprise a second set of switches 61, 62, 63 connected in parallel with each of the plurality of coils 41, 42, 43. The second set of switches 61, 62, 63 may be used to soften the impact on the voltage of changing the number of turns in the primary winding 20 with the first set of switches 51, 52, 53. Thus, providing a smoother change in the voltage induced in the secondary winding 30 by the primary winding 20 when the turns ratio is changed. Each of the second set of switches 61, 62, 63 may be connected in series with a resistor (not shown) to further smooth the change in the voltage induced in the secondary winding 30 when the number of turns in the primary winding 20 are changed.

The number of turns in each coil 41, 42, 43 may be chosen to provide voltage changes in the secondary winding 30 of a similar magnitude to the fluctuations in the voltage of the live supply 31. For example, the transformer 10 may provide a turns ratio of 5:1, 10:1 and 20:1 by having 40 turns in the first coil 41 and second coil 42, 80 turns in the third coil 43 and 8 turns in the secondary winding 30. However, the transformer 10 may have different numbers of turns in the coils of the primary and secondary windings and, thus, provide different turns ratios. In certain embodiments, the transformer 10 may provide a turns ratio that varies in the range between 2:1 and 50:1. In certain embodiments, the first coil may have a turns ratio between 3:1 and 7:1, the second coil may have a turns ratio between 8:1 and 12:1 and the third coil may have a turns ratio between 15:1 and 25:1.

The transformer 10 is not limited to the arrangement shown in FIG. 1. The plurality of coils 41, 42, 43 in the primary winding 20 may comprise more than three coils connectable in series or the primary winding 20 may comprise two coils connectable in series. Furthermore, the first set of switches 51, 52, 53 may comprise one or more switches. The number of switches in the first set of switches 51, 52, 53 may correspond to the number of coils 41, 42, 43 in the primary winding 20 such that a switch is connected to the output of each of the plurality of coils 41, 42, 43. Additionally, the second set of switches 61, 62, 63 may comprise one or more switches where a switch is connected in parallel with each of the plurality of coils 41, 42, 43.

In use, the number of turns in the primary winding 20 connected to the primary AC electrical supply 21 may be chosen to provide the adjustment required to regulate the voltage supplied to the load 32 whilst keeping the current in the primary winding 20 below a threshold value. In the example given above, the turns ratio of the transformer 10 may be set to 5:1, 10:1 or 20:1. If the primary AC electrical supply 21 provides 230 V to the primary winding 20, the transformer 10 can adjust the voltage supplied to the load 32 by 46 V, 23 V, and 11.5 V when the transformer 10 uses a turns ratio of 5:1, 10:1 and 20:1, respectively. Thus, during use the turns ratio may be selected to produce the required adjustment in the voltage provided to the load 32, while also ensuring the primary current does not exceed device limits.

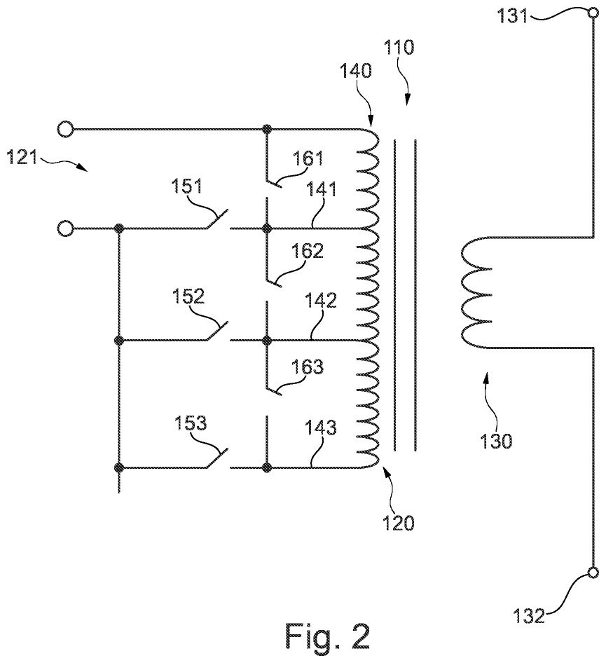

An alternative embodiment of the transformer 110 is shown in FIG. 2. Reference numerals in FIG. 2 correspond to those used in FIG. 1 with respect to alike components and features but are transposed by 100. The embodiment of FIG. 2 differs from that of FIG. 1 in that the primary winding 120 may comprise a tapped coil 140. Each tap 141, 142, 143 of the coil 140 may be connected to one of the first set of switches 151, 152, 153. The first set of switches 151, 152, 153 are operable to change the number of turns of the coil 140 that are connected to the primary AC electrical supply 121. In the embodiment shown in FIG. 2, the coil 140 comprises a first 141, a second 142 and a third 143 tap connected to a first 151, a second 152 and a third 153 switch, respectively. In the same manner as described for FIG. 1, when the first switch 151 is closed and the second 152 and third 153 switches are open, only the turns in the coil 140 preceding the first tap 141 are connected to the primary AC electrical supply 121. To increase the turns ratio and connect all the turns preceding the second tap 142, the first 151 and third 153 switches are open, and the second switch 152 is closed. Finally, to connect all turns in the coil 140 to the primary AC electrical supply 121, the first 151 and second 152 switches are open, and the third switch 153 is closed.

As shown in FIG. 2, the switching means may comprise a second set of switches 161, 162, 163 connected between each tap 141, 142, 143 to soften the impact on the voltage of changing the number of turns in the primary winding 120 with the first set of switches 151, 152, 153. Each of the second set of switches 161, 162, 163 may be connected in series with a resistor (not shown) to further smooth the change in the voltage when the number of turns in the primary winding 120 are changed.

The number of turns between each tap may be chosen to provide a voltage change in the secondary winding 130 of similar magnitude to the fluctuations in the voltage of the live supply 131. For example, the transformer 110 may provide a turns ratio of 5:1, 10:1 and 20:1 by having turns preceding the first tap 141, 40 turns between the first 141 and second 142 taps and 80 turns between the second 142 and third 143 taps. However, the transformer 110 may have alternative turns ratios. In certain embodiments, the transformer 10 may provide a tur [0039] ns ratio that is variable between 2:1 and 50:1. In certain embodiments, the first tap 141 may have a turns ratio between 3:1 and 7:1, the second tap 142 may have a turns ratio between 8:1 and 12:1 and the third tap 143 may have a turns ratio between 15:1 and 25:1. Additionally, the number of taps in the transformer 110 is not limited to three. Any suitable number of taps and turns between the taps may be used to regulate the voltage supplied to the load 132.

Although the embodiments of FIGS. 1 and 2 have different physical arrangements for the primary winding, the two embodiments are electrically equivalent and operate in effectively the same way. In both embodiments, turns of the primary winding are connected in series by the first set of switches.

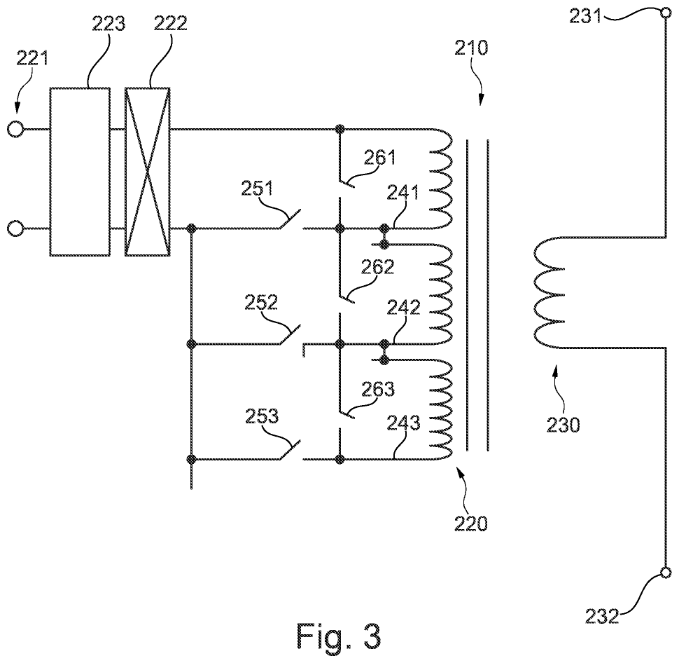

A further embodiment of the invention is shown in FIG. 3. In addition to varying the turns ratio of the transformer 210 to regulate the voltage supplied to the load 232, the primary AC electrical supply 221 may be coupled to a switching device 222 to invert the connection of the primary winding 220 to the primary AC electrical supply 221, as shown in FIG. 3. Reference numerals in FIG. 3 correspond to those used in FIG. 2 with respect to alike components and features but are transposed by 100. The switching device 222 may be arranged to selectively apply the voltage of the primary AC electrical supply 221 to the primary winding 220 in first and second directions. In the first direction, the switching device 222 is arranged to apply the voltage of the primary AC electrical supply 221 to the primary winding 220 such that a negative voltage is induced in the secondary winding 230. In use, the negative voltage is summed with the supply, reducing the voltage supplied to the load 232. Thus, the first direction may be used to regulate the voltage provided to the load 232 when the voltage of the live supply 231 is greater than the intended supply voltage for supply to the load 232. In the second direction, the switching device 222 is arranged to apply the voltage of the primary AC electrical supply 221 to the primary winding 220 such that a positive voltage is induced in the secondary winding 230. The positive voltage is added to the voltage of the live supply 231 to increase the voltage supplied to the load 232. Thus, the second direction may be used to regulate the voltage provided to the load 232 when the voltage of the live supply 231 is less than the intended supply voltage. The switching device 222 may comprise any suitable device; in certain embodiments, the switching device 222 may comprise a changeover relay.

The voltage induced in the secondary winding 230 by the primary winding may be further adjusted by a power converter 223. In certain embodiments, the primary AC electrical supply 221 may comprise a power converter 223. The power converter 223 may continuously vary the voltage applied to the primary winding 220 within the voltage range of the power converter 223. In certain embodiments, the power converter 223 may be arranged to vary the voltage applied to the primary winding 220 from 0 V to 250 V. By changing the voltage supplied to the primary winding 220 the voltage induced in the secondary winding 230 may be further adjusted. Additionally, the power converter 223 may be used to ramp the voltage supplied to the primary winding 220 to ensure a smooth change in the voltage induced in the secondary winding 230 when the turns ratio of the transformer 10 is changed. In the embodiment shown in FIG. 3, the primary AC electrical supply 221 is coupled to a switching device 222 and comprises a power converter 223. However, in certain embodiments the primary AC electrical supply 221 may be coupled to the switching device 222 without the primary AC electrical supply 221 comprising a power converter 223.

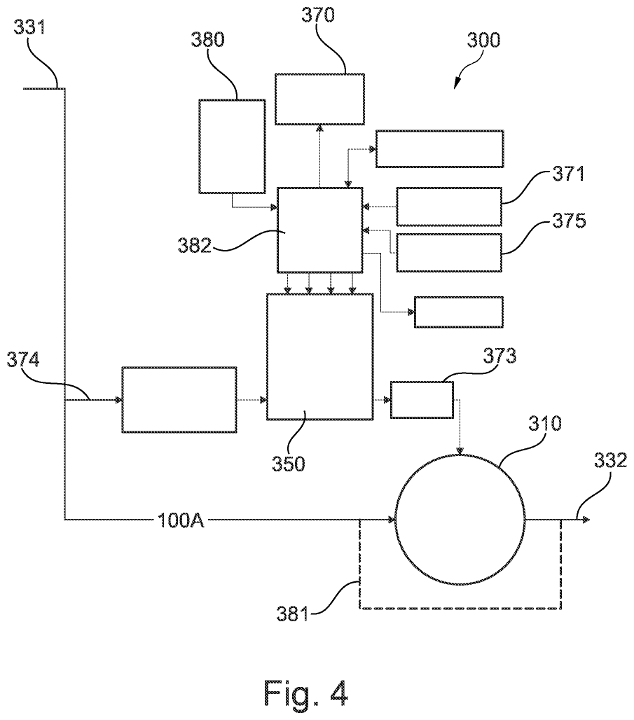

FIG. 4 shows a system 300 according to an embodiment of the invention. Reference numerals in FIG. 4 correspond to those used in FIG. 3 with respect to alike components and features but are transposed by 100. The system 300 comprises a transformer 310 and is configured to regulate the voltage of a live supply 331 to provide a load 332 with the intended supply voltage whilst keeping the current in a primary winding of the transformer 310 below a threshold value. The primary winding of the transformer 310 is connected to a primary AC electrical supply 374 and the primary AC electrical supply 374 may be coupled to a switching device 373 as described above. A secondary winding of the transformer 310 is connected in series between the live supply 331 and the load 332.

The system 300 further comprises a detection means 380 and a control means or control module 382. The detection means 380 is arranged to continuously or intermittently measure voltage of the live supply 331 and/or the voltage delivered to the load 332. The detection means 380 may comprise a voltmeter for measuring the voltages. In certain embodiments, the voltage of the live supply 331 and/or the output of the secondary winding may be measured every 0.5 s.

The control means 382 is configured to receive data relating to the measured voltage of the live supply 331 and/or output of the secondary winding of the transformer 310 from the detection means 380. In use, the control means 382 compares the measured voltage with the intended supply voltage for the load 332 to determine the adjustment required to the voltage supplied to the load 332. If the measured voltage data of the live supply 331 is received by the control means 382, the control means 382 can determine the required adjustment to the voltage. If the measured output voltage data of the secondary winding is received by the control means 382, the control means 382 can determine whether further adjustment, in addition to that already being applied by the transformer 310, is required. The control means 382 can then determine the turns ratio of the transformer 310 required to account for the difference between the voltage of the live supply 331 and the intended supply voltage.

The control means 382 is operably coupled to the switching means (not shown) of the transformer 310. Thus, the control means 382 can operate the switching means to change the number of turns of the primary winding connected to the primary AC electrical supply 374 in response to the measured voltage. As such, during use, the turns ratio of the transformer 310 can be changed to regulate the voltage supplied to the load 332.

Additionally, in determining the adjustment required to the voltage supplied to the load 332, the control means 382 is configured to determine whether the voltage of the live supply 331 needs to be increased or decreased to provide the intended supply voltage. The control means 382 is coupled to the switching device 373. Thus, if the voltage of the live supply 331 is greater than the intended supply voltage, the control means 3812 causes the switching device 373 to connect the primary winding to the primary AC electrical supply 374 in the first direction. Alternatively, if the voltage of the live supply 331 is less than the intended supply voltage, the control means 382 causes the switching device 373 to connect the primary winding to the primary AC electrical supply 374 in the second direction.

The system 300 may comprise a first current sensor (not shown) arranged to measure the current in the secondary winding of the transformer 310 and hence the load 332. The first current sensor may be arranged to continuously or intermittently measure current in the secondary winding and the load 332. The current sensor may be a Hall effect sensor or similar device for measuring the current. The control means 382 may be configured to receive data relating to the measured current from the current sensor. In use, when the control means 382 determines the turns ratio of the transformer 310 required to address the difference between the voltage of the live supply 331 and the intended supply voltage, the control means 382 may also consider the measured current in the secondary winding before modifying the turns ratio. If the measured current of the secondary winding and load is above a threshold value for the secondary winding and load, the turns ratio of the transformer is modified to keep the current in the primary winding of the transformer 310 below a threshold value of the primary winding. As such, the load voltage adjustment capability is sacrificed so that the current in the primary winding may be kept below a threshold value. By keeping the current in the primary winding below a threshold value, large and expensive components are not required on the primary side of the transformer 310.

In certain embodiments, the primary AC electrical supply 374 may comprise a power converter 350. In such embodiments, the control means 382 is coupled to the power converter 350 to control the voltage provided to the primary winding. The control means 382 may cause the power converter 350 to ramp the voltage supplied to the primary winding to ensure a smooth change in the voltage induced in the secondary winding when the turns ratio of the transformer 310 is changed. The power converter 350 enables fine control of the voltage supplied to the primary winding.

The system 300 may further comprise a bypass mechanism 370. The bypass mechanism 370 may be operated to connect the secondary winding between the live supply 331 and the load 332 or to connect the live supply 331 directly to the load 332 (i.e. bypassing the secondary winding). In certain embodiments, the bypass mechanism 370 may comprise a switch operable to connect either the secondary winding between the live supply 331 and the load 332 or the live supply 331 directly to the load 332. The load 332 may be directly coupled to the live supply 331 by a bypass path 381. The bypass mechanism 370 is controlled by the control means 382. The control means 382 may cause the bypass mechanism 370 to either engage or disengage. When the bypass mechanism 370 is disengaged the secondary winding is connected between the live supply 331 and the load 332 and when the bypass mechanism 370 is engaged the live supply 331 is connected directly to the load 332. The system 300 may be configured to engage the bypass mechanism 370 in one or more of the conditions described below.

The bypass mechanism 370 may be engaged to allow cooling of the transformer 310. In such embodiments, the system 300 comprises a temperature sensor 371 arranged to continuously or intermittently measure the temperature of the transformer 310. A signal is fed from the temperature sensor 371 to the control means 382, which when a certain temperature threshold is reached or exceeded, outputs a signal to engage the bypass mechanism 370. Thus, connecting the live supply 331 directly to the load 332. When the bypass mechanism 370 is engaged the transformer 310 is allowed to cool. The temperature sensor 371 continues to measure the temperature of the transformer 310 and to feed the signal to the control means 382. Once the temperature has fallen below a threshold temperature, the control means 382 outputs a signal to disengage the bypass mechanism 370. Thus, the secondary winding is reconnected between the live supply 331 and the load 332.

In certain embodiments, the bypass mechanism 370 may be engaged when the voltage of the live supply 331 is within a specified range of the intended supply voltage. As discussed above, the control means 382 receives a signal from the detection means 380 relating to the voltage of the live supply 331 and/or the output of the secondary winding. When the measured voltage is within a first range of the intended supply voltage the control means 382 outputs a signal to engage the bypass mechanism 370. The bypass mechanism 370 may be engaged when the voltage of the live supply 331 is within 2 V, 4V or 6 V of the intended supply voltage. The detection means 380 continues to monitor the voltage of the live supply 331 and/or the output of the secondary winding and feed the signal to the control means 382. Once the voltage deviates beyond a second range, the bypass mechanism 370 is disengaged. The second range may be larger than the first range. The bypass mechanism 370 may be disengaged when the voltage of the live supply 331 differs by 4 V, 6 V or 8 V from the intended supply voltage.

In certain embodiments, the bypass mechanism 370 may be engaged when there is excessive noise on the live supply 331 voltage. Ideally, the voltage of the live supply 331 is sinusoidal. However, noise can cause the live supply 331 voltage to deviate from this form. The system 300 may comprise a monitoring means 375 to measure the noise on the live supply 331. The monitoring means 375 may measure the noise by monitoring current spikes and transients in the live supply 331. In certain embodiments, the monitoring means 375 may trip in response to current spikes and transients in the live supply 331. A signal is fed from the monitoring means 375 to the control means 382, which when the noise on the live supply 331 is above a threshold level, outputs a signal to engage the bypass mechanism 370; thus, connecting the live supply 331 directly to the load 332. The monitoring means 375 continues to measure the noise on the live supply 331 and feed the signal to the control means 382. Once the noise has fallen below a predetermined level, the control means 382 outputs a signal to disengage the bypass mechanism 370; thus, the secondary winding is reconnected between the live supply 331 and the load 332. Bypassing the transformer 310 is advantageous when there is a high level of noise on the live supply 331 because noise on the live supply 331 can cause the power converter 350 to operate incorrectly leading to damage to the primary-side components.

In certain embodiments, the bypass mechanism 370 may be engaged when there is a short circuit in the load 332. The system 300 may comprise a second current sensor (not shown) arranged to measure the current in the secondary winding. In certain embodiments, the second current sensor may be the same sensor as the first current sensor. When the current rapidly rises or increases above a certain value, this may indicate that a short circuit has occurred in the load 332. In a similar manner as discussed above, a signal is fed from the second current sensor to the control means 382, which when the current exceeds a predetermined value, outputs a signal to engage the bypass mechanism 370; thus, connecting the live supply 331 directly to the load 332. The second current sensor continues to measure the current and feed the signal to the control means 382. Once the current has fallen below the predetermined value, the control means 382 outputs a signal to disengage the bypass mechanism 370; thus, the secondary winding is reconnected between the live supply 331 and the load 332. Bypassing the transformer 310 is advantageous when there is a short circuit because a high current in the secondary winding will produce a high current in the primary windings, thereby damaging components on the primary side of the transformer 310.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1-24. (canceled)

25. A transformer for adjusting the voltage delivered to a load, the transformer comprising:
a primary winding connectable to a primary AC electrical supply;
a secondary winding connectable in series between a live supply and a load;
wherein the primary winding comprises a switching means operable to change the number of turns of the primary winding connectable to the primary AC electrical supply;
wherein the number of turns of the primary winding connectable to the primary AC electrical supply is greater than a number of turns in the secondary winding; and
wherein the switching means comprises one or more solid state switches.

26. The transformer of claim 25, wherein the primary winding comprises a plurality of coils, and wherein the switching means is operable to connect one or more of the plurality of coils in series.

27. The transformer of claim 26, wherein the switching means comprises a set of first switches operable to change the number of turns of the primary winding connectable to the primary AC electrical supply, and wherein the output of each of the plurality of coils in the primary winding is connected to one of the first switches.

28. The transformer of claim 27, wherein the switching means comprises a set of second switches connected in parallel with each of the plurality of coils.

29. The transformer of claim 25, wherein the primary winding comprises a tapped coil.

30. The transformer of claim 29, wherein the switching means comprises a set of first switches operable to change the number of turns of the primary winding connectable to the primary AC electrical supply, and wherein the output of the tapped coil in the primary winding is connected to one of the first switches.

31. The transformer of claim 30, wherein the switching means comprises a set of second switches connected between each tap of the tapped coil.

32. The transformer of claim 28, comprising a resistor connected in series with each of the second switches.

33. The transformer of claim 25, wherein the first switching means is operable to change the number of turns of the primary winding that are connectable to the primary AC electrical supply so that the transformer has a turns ratio of X:1, where X is between 2 and 50.

34. The transformer of claim 33, wherein X is between 3 and 7, 8 and 12, or 15 and 25.

35. The transformer of claim 25, wherein the first switching means is operable to change the number of turns of the primary winding that are connectable to the primary AC electrical supply so that the transformer has a turns ratio of 5:1, 10:1 and 20:1.

36. The transformer of claim 25, wherein the primary winding is connected to a primary AC electrical supply and wherein the secondary winding is connected in series between a live supply and a load.

37. A system for adjusting the voltage received by a load, comprising:
a transformer according to claim 25, wherein the secondary winding is connected in series between a live supply and a load;
a detection means configured to measure a voltage of the live supply and/or the voltage delivered to the load;
a control means operably coupled to the switching means and configured to receive data relating to the measured voltage of the live supply and/or live output from the detection means;
wherein the control means is configured to operate the switching means to change the number of turns of the primary winding connectable to the primary AC electrical supply in response to the received measured voltage data so that, in use, the voltage delivered to the load is adjusted.

38. The system of claim 37, comprising a first current sensor arranged to measure the current in the secondary winding or the load, wherein the control means is arranged to receive a signal from the first current sensor and the control means is configured to operate the switching means to change the number of turns of the primary winding connectable to the primary AC electrical supply in response to the received measured current data so that, in use, the current in the primary winding below the threshold value for the primary winding.

39. The system of claim 37, comprising a bypass mechanism controllable by the control means, wherein the bypass mechanism is configured to connect either the secondary winding between the live supply and the load or the live supply directly to the load.

40. The system of claim 37, comprising a temperature sensing means to determine the temperature of the transformer, wherein the control means is arranged to receive a signal from the temperature sensing means and operate the bypass mechanism in dependence on the determined temperature.

41. The system of claim 38, wherein the control means is arranged to operate the bypass mechanism when the determined temperature is at or above a threshold temperature.

42. The system of claim 38, comprising a second current sensor arranged to measure the current in the secondary winding, wherein the control means is arranged to receive a signal from the second current sensor and operate the bypass mechanism in dependence on the measured current.

43. The system of claim 42, wherein the control means is arranged to operate the bypass mechanism when the measured current is at a threshold current.

44. The system of claim 38, wherein the control means is arranged to control the bypass mechanism to connect the live supply directly to the load when the measured voltage of the live supply is within a first range of an intended supply voltage for the load and, optionally, wherein the first range is ±2 V, ±4 V or ±6 V from the intended supply voltage.

45. The system of claim 44, wherein the control means is arranged to control the bypass mechanism to connect the secondary winding between the live supply and the load when the measured voltage of the live supply deviates from the intended supply voltage for the load by a second range and, optionally, wherein the second range is ±4 V, ±6 V or ±8 V from the intended supply voltage.

46. The system of claim 37, wherein the bypass mechanism comprises a bypass path to connect the live supply directly to the load.

47. The system of claim 37, comprising a switching device to control the orientation of the connection of the primary winding to the primary AC electrical supply, wherein the switching device is controllable by the control means.
